(19) United States
(12) Patent Application Publication
(10) Pub. No.: US 2022/0320556 A1
(43) Pub. Date: Oct. 6, 2022

(54) PROTON CONDUCTING MEMBRANE CONTAINING PROTON-DONATING GROUP AND FUEL CELL

(71) Applicants: TOYOTA JIDOSHA KABUSHIKI KAISHA, Toyota-shi (JP); National University Corporation Tokai National Higher Education and Research System, Nagoya-shi (JP)

(72) Inventors: Naoki NAKAMURA, Sunto-gun (JP); Masaki ANDO, Gotemba-shi (JP); Atsushi NORO, Nagoya-shi (JP); Takato KAJITA, Nagoya-shi (JP); Katsumi SATO, Nagoya-shi (JP)

(21) Appl. No.: 17/657,246

(22) Filed: Mar. 30, 2022

(30) Foreign Application Priority Data
Mar. 31, 2021 (JP) 2021-061640

(51) Int. Cl. H01M 8/1027; H01M 8/1067

(52) U.S. Cl. CPC H01M 8/1027; H01M 8/1067

(57) ABSTRACT

[Problem] Provided is a proton-conducting membrane that exhibits high proton conductivity even in low-humidity or anhydrous environments.

[Solving means] A proton-conducting membrane that comprises a crosslinked polymer and a plasticizer, wherein the crosslinked polymer contains repeating units containing proton-donating groups in an amount equal to 10 mol % or more of repeating units constituting the crosslinked polymer, and at least 60 mass % of the plasticizer is a proton-donating compound with a pKa of 2.5 or less, and, the proton-conducting membrane is a viscoelastic solid in the temperature range of from 20° C. to 125° C.

### FIELD

The present disclosure relates to a proton-conducting membrane containing a proton-donating group and a fuel cell using the same.

### BACKGROUND

Conventionally, perfluorosulfonic acid resin membranes, such as Nafion (registered trademark, same hereinafter), have been known as proton-conducting membranes used as electrolyte materials for fuel cells. However, in order to achieve high proton conductivity with such perfluorosulfonic acid resin membranes, presence of water is essential. For this reason, fuel cells that contain such perfluorosulfonic acid resin membranes need to limit the operating temperature to below the boiling point of water.

Therefore, proton-conducting membranes that can be used in low-humidity or anhydrous environments have been developed.

For example, PTL 1 discloses a proton-conducting membrane comprising a crosslinked polymer and a plasticizer, wherein the crosslinked polymer includes a proton-acceptor group in an amount equal to 10 mol % or more of repeating units constituting the crosslinked polymer, wherein the plasticizer includes a proton donor compound having a pKa value 2.5 or less, and wherein the proton-conducting membrane is a viscoelastic solid in a temperature range of from 50° C. to 120° C.

PTL 2 discloses a proton-conducting polymer membrane which comprises polyazoles with sulfonic acid groups containing a benzimidazole unit and is obtainable by a process including a specific step.

PTL 3 discloses a solid polymer electrolyte membrane comprising a crosslinked polymer and a plasticizer, wherein at least one of the crosslinked polymer and the plasticizer has a proton-releasing group.

PTL 4 discloses a solid polymer electrolyte membrane used as an electrolyte membrane in a solid polymer electrolyte fuel cell, said electrolyte membrane comprising: a main-polymer having acidic sites or basic sites; and a sub-polymer capable of forming acid/base composite structure together with said main-polymer, wherein said sub-polymers are introduced more into the acidic or basic sites of said main-polymer.

### CITATION LIST

### Patent Literature

### [PTL 1] Japanese Unexamined Patent Publication 2019-135715

### [PTL 2] Japanese Unexamined Patent Publication 2011-080075

### [PTL 3] Japanese Unexamined Patent Publication 2018-190647

### [PTL 4] Japanese Unexamined Patent Publication 2001-236973

### SUMMARY

### Technical Problem

However, there is still room for improvement in the proton conductivity of conventional proton-conducting membranes that can be used in low-humidity or anhydrous environments.

The present disclosure aims to improve the above-described circumstances, and an object thereof is to provide a proton-conducting membrane that exhibits a high proton conductivity even in low-humidity or anhydrous environments.

### Solution to Problem

The present disclosure, which attains the above-described object, is as follows.

<Aspect 1>

A proton-conducting membrane, comprising:

a crosslinked polymer and a plasticizer,

wherein the crosslinked polymer includes repeating units containing proton-donating groups in an amount equal to 10 mol % or more of repeating units constituting the crosslinked polymer,

wherein at least 60 mass % of the plasticizer is a proton-donating compound with a pKa of 2.5 or less, and,

wherein the proton-conducting membrane is a viscoelastic solid in a temperature range of from 20° C. to 125° C.

<Aspect 2>

The proton-conducting membrane according to aspect 1, wherein at least 80 mass % of the plasticizer is the proton-donating compound.

<Aspect 3>

The proton-conducting membrane according to aspect 1 or 2, wherein the repeating unit containing a proton-donating group is in an amount equal to 50 mol % or more of the repeating units constituting the crosslinked polymer.

<Aspect 4>

The proton-conducting membrane according to any one of aspects 1 to 3, wherein the molar ratio of the plasticizer to the repeating unit containing the proton-donating group (the plasticizer/the repeating unit containing the proton-donating group) is from 0.4 to 8.0.

<Aspect 5>

The proton-conducting membrane according to any one of aspects 1 to 4, wherein when the total of the crosslinked polymer and the plasticizer is 100 parts by mass, the content of the plasticizer is from 20 parts by mass to 90 parts by mass.

<Aspect 6>

The proton-conducting membrane according to any one of aspects 1 to 5, wherein the molar ratio of the plasticizer to the repeating units containing proton-donating group (the plasticizer/the repeating unit containing the proton-donating group) is from 1.0 to 8.0.

<Aspect 7>

The proton-conducting membrane according to any one of aspects 1 to 6, wherein when the total of the crosslinked polymer and the plasticizer is 100 parts by mass, the content of the plasticizer is from 50 parts by mass to 90 parts by mass.

<Aspect 8>

The proton-conducting membrane according to any one of aspects 1 to 7, wherein the proton-donating compound is one or more selected from the group consisting of sulfuric acid and phosphoric acid.

<Aspect 9>

The proton-conducting membrane according to any one of aspects 1 to 8, wherein the proton-donating group is at least one selected from the group consisting of a sulfonic acid group, a phosphonic acid group, and a carboxylic acid group.

<Aspect 10>

The proton-conducting membrane according to any one of aspects 1 to 9, wherein the crosslinked polymer is a copolymer of a first monomer, which is a vinyl monomer containing a proton-donating group, and a second monomer, which is a crosslinkable vinyl monomer.

<Aspect 11>

The proton-conducting membrane according to any one of aspects 1 to 10, wherein the proton conductivity is 0.00048 S/cm or more at 50° C.

<Aspect 12>

A fuel cell comprising the proton-conducting membrane according to any one of aspects 1 to 11.

### Advantageous Effects of Invention

The proton-conducting membranes of the present disclosure can exhibit a high proton conductivity even in low-humidity or anhydrous environments.

Therefore, the proton-conducting membrane of the present disclosure is particularly suitable for use as a proton-conducting membrane in fuel cells.

### BRIEF DESCRIPTION OF DRAWINGS

FIG. 1 is a schematic view for illustrating the mechanism by which the function of the proton-conductive membrane of the present disclosure is brought about.

FIG. 2 is a photograph of the proton-conducting membrane of Example 1.

FIG. 3 is a view showing proton conductivities of the proton-conducting membranes of Example 1 and Comparative Examples 1 to 3.

FIG. 4 is a view showing proton conductivities of the proton-conducting membranes of Examples 1 to 3 and Comparative Examples 4 to 5.

FIG. 5 is a view showing proton conductivities of the proton-conducting membranes of Examples 1, 4, and 5 and Comparative Example 1.

### DESCRIPTION OF EMBODIMENTS

Hereinafter, embodiments of the present disclosure will be described in detail. The present disclosure is not limited to the following embodiments, and can be implemented with various modifications within the scope of the spirit of the invention.

<<Proton-Conducting Membrane>>

The proton-conducting membrane of the present disclosure comprises

a crosslinked polymer and a plasticizer,

wherein the crosslinked polymer includes repeating units containing proton-donating groups in an amount equal to 10 mol % or more of repeating units constituting the crosslinked polymer,

wherein at least 60 mass % of the plasticizer is a proton-donating compound with a pKa of 2.5 or less, and,

wherein the proton-conducting membrane is a viscoelastic solid in a temperature range of from 20° C. to 125° C.

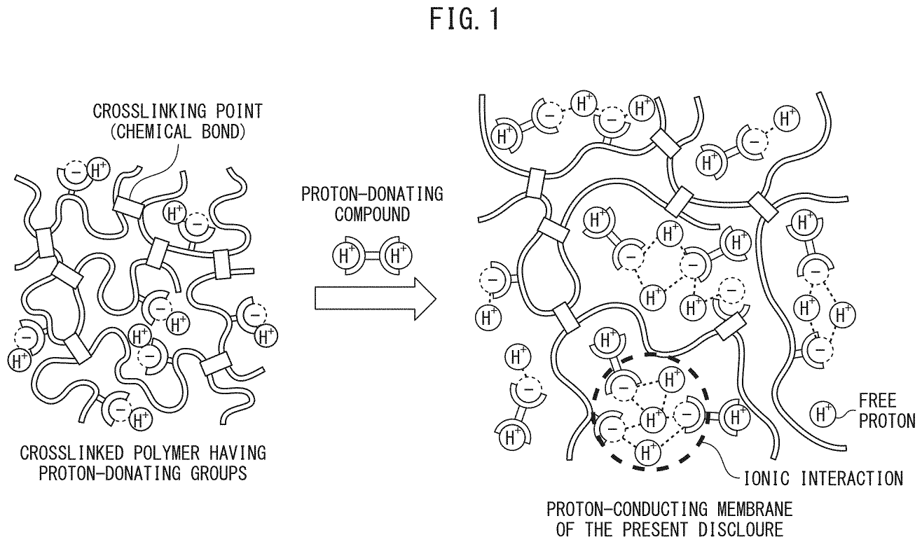

In the following, the mechanism by which the proton-conducting membrane of the present disclosure exhibits a function will be described using FIG. 1. However, the mechanism described below are not intended to limit the present disclosure.

FIG. 1 is a schematic view for illustrating the mechanism by which the function of the proton-conductive membrane of the present disclosure is brought about.

As illustrated in FIG. 1, the proton-conducting membrane of the present disclosure comprises a crosslinked polymer and a plasticizer. Herein, the crosslinked polymer contains a repeating unit having a proton-donating group, and crosslinks at a crosslinking point to form a crosslinked structure. In FIG. 1, the plasticizer is denoted as a “proton-donating compound”. This “proton-donating compound” is denoted as a proton-donating dibasic acid, but is not limited to this embodiment.

In order to improve the proton conductivity of a proton-conductive membrane, for example, the membrane is considered to contain a high concentration of free protons. However, in conventional proton-conducting membranes, it is not easy to increase the concentration of free protons in the membrane.

For example, in Comparative Example 4 as described later, an attempt was made to introduce a proton-donating compound (sulfuric acid) as a plasticizer to a Nafion membrane, but only about 15 parts by mass of the plasticizer were introduced, relative to the total 100 parts by mass of the Nafion membrane and the plasticizer. In the proton-conducting membrane described in PTL 1, crosslinked poly(4-vinylpyridine) (“crosslinked P4VP”) is used as a crosslinked polymer, but since the polymer contains a proton accepting-group, even when a proton-donating plasticizer is introduced, free protons released from the proton-donating plasticizer are consumed by the proton accepting-group in the crosslinked polymer. Therefore, in the proton-conducting membrane of PTL 1, it was difficult to increase the concentration of free protons in the membrane, particularly when the concentration of a proton-donating plasticizer was low, and the conductivity was as low as 0.00015 S/cm (0.15 mS/cm) at 120° C. under non-humidified conditions, even when a proton-donating plasticizer (i.e. H₂SO₄) as much as 55 parts by mass was introduced, relative to the total of 100 parts by mass of the membrane composed of crosslinked P4VP and H₂SO₄ which was a proton-donating plasticizer, as illustrated in Comparative Example 5 below.

In PTL 3, as a proton-conducting membrane, a proton-conducting membrane prepared from a crosslinked polymer and a plasticizer is discloesed, wherein crosslinked poly(2-acrylamido-2-methylpropanesulfonic acid) (“crosslinked PAMPS”) is used as the crosslinked polymer with proton-donating groups and a mixture composed of uncrosslinked polystyrene sulfonic acid (“uncrosslinked PSS”) and tetraethylene glycol (“TEG”) (1:7 by weight) is used as the proton-donating plasticizer. Although as many as 80 parts by mass of a proton-donating plasticizer were introduced when the total mass of the entire membrane was 100 parts by mass, the mass concentration of a compound with a proton-donating group in the plasticizer (i.e. uncrosslinked PSS) was as low as 12.5 mass % (=⅛), and the conductivity was as low as 0.0018 S/cm at 95° C. under non-humidified conditions.

Similarly, in PTL 3, as a proton-conducting membrane, a proton-conducting membrane prepared from a crosslinked polymer and a plasticizer is disclosed, wherein crosslinked polyacrylic acid-4-hydroxybutyl (“crosslinked PHBA”) is used as the crosslinked polymer with proton-accepting groups and a mixture of bis(trifluoromethanesulfonyl)imide (“HTFSI”) and tetraethylene glycol (“TEG”) (58:42 by weight) is used as the proton-donating plasticizer. Although as many as 63 parts by mass of a proton-donating plasticizer were introduced when the total mass of the entire membrane was 100 parts by mass, the crosslinked polymer did not contain proton-donating functional groups, and the mass concentration of a compound with a proton-donating group in the plasticizer (i.e. uncrosslinked HTFSI) was as low as 58 mass %, and the conductivity was as low as 0.0011 S/cm at 95° C. under non-humidified conditions.

In contrast to these, in the proton-conducting membranes of the present disclosure, as shown in FIG. 1, a crosslinked polymer comprises a proton-donating group, and a plasticizer also contains a high concentration of a proton-donating compound (for example, at least 60 mass % of the plasticizer). Therefore, in the membrane, the proton-donating groups of the crosslinked polymer and the high concentration of proton-donating compounds in the plasticizer can become anions by releasing protons. The free protons (also called “released prontons”) can then easily migrate through anionic portions of the crosslinked polymer and anionic portions of the plasticizer, even in a low-humidity or anhydrous environment, and therefore a high proton conductivity can be obtained.

Surprisingly, a combination of a crosslinked polymer containing a proton-donating group and a proton-donating compound as a plasticizer can produce an ionic interaction between a free proton and each anion in the proton-conducting membrane of the present disclosure. This would make the plasticizer less likely to bleed out of the membrane. Therefore, a relatively large amount of plasticizer (for example, about 90 parts by mass of plasticizer relative to 100 parts by mass of the total of a crosslinked polymer and a plasticizer) can be introduced into the proton-conducting membrane of the present disclosure, and a higher proton conductivity than conventional ones can be obtained.

On the other hand, since proton-donating groups are present in the crosslinked polymer of the present disclosure, the concentration of free protons in the membrane can be secured even with a relatively small amount of plasticizer (for example, about 20 parts by mass of a plasticizer with respect to 100 parts by mass of the total of a crosslinked polymer and the plasticizer). In other words, the proton-conducting membrane of the present disclosure can obtain a higher proton conductivity than the proton-conducting membrane of PTL 1, which contains the same amount of plasticizer as that of the present disclosure.

In the present disclosure, “viscoelastic solid” refers to a solid that is viscous and elastic, does not exhibit fluidity, and maintains its shape. Specifically, a material that is a “viscoelastic solid” has a property that, when a stress is applied to the material to produce a small deformation, the stress on the deformation reaches the maximum immediately after the deformation and decreases with time, but eventually reaches a constant value that is not zero, and when the stress that caused the deformation is removed, the deformation becomes smaller and in some cases returns to its original shape.

The proton-conducting membrane of the present disclosure can be a viscoelastic solid in a temperature range of from 20° C. and 125° C. This temperature range may be more specifically, for example, 15° C. or more, 10° C. or more, 5° C. or more, or 0° C. or more, or may be 130° C. or less, 140° C. or less, or 150° C. or less.

In the present disclosure, no bleeding out of a plasticizer means that the plasticizer does not leak out of the proton-conducting membrane, when the proton-conducting membrane is allowed to stand still for one hour under no load in the operating temperature range of a battery.

As used herein, the term “(meth)acrylic acid” is a concept that encompasses both acrylic acid and methacrylic acid. The terms “(meth)acrylate”, “(meth)acrylamide”, and the like should be understood accordingly. The term “(poly)oxyalkylene” refers to a single oxyalkylene unit or a chain of two or more oxyalkylene units.

The term “alkylene group” as used herein is a concept encompassing a methylene group, an alkylmethylene group, and a dialkylmethylene group.

<Crosslinked Polymer>

In the present disclosure, the crosslinked polymer includes repeating units containing proton-donating groups in an amount equal to 10 mol % or more of repeating units constituting the crosslinked polymer.

The presence of 10 mol % or more of repeating units containing proton-donating groups in the crosslinked polymer is preferable from the viewpoint of ensuring a sufficient concentration of free protons in the membrane, contributing to sufficiently high proton conductivity, and suppressing bleeding out of the plasticizer through an ionic interaction.

The proportion thereof may be, for example, 10 mol % or more, 20 mol % or more, 30 mol % or more, 40 mol % or more, 50 mol % or more, 60 mol % or more, 70 mol % or more, 80 mol % or more, 90 mol % or more, or 100 mol %, or may be 100 mol % or less, 95 mol % or less, or 90 mol % or less. Here, the proportion of 100 mol % means that all of the repeating units constituting the crosslinked polymer contain proton-donating groups.

Herein, the proton-donating group is preferably at least one selected from the group consisting of a sulfonic acid group, a phosphonic acid group, and a carboxylic acid group, and more preferably at least one selected from the group consisting of a sulfonic acid group and a phosphonic acid group. Herein, the repeating unit constituting the crosslinked polymer may contain one or more kinds of proton-donating groups.

Herein, the crosslinked polymer can maintain the membrane shape even at temperatures higher than the glass transition point due to the crosslinked structure.

The crosslinked polymer may have a favorable miscibility with the plasticizer as described below. The favorable miscibility between the crosslinked polymer and the plasticizer enables the glass transition point Tg of the proton-conducting membrane, which is the mixture of both, to be sufficiently low. In this case, the molecular mobility of the proton-conducting mixed phase in the membrane can be made sufficiently high, which will result in high proton conductivity.

The crosslinked polymer, in combination with the plasticizer described below, forms the proton-conducting membrane that is a viscoelastic solid, thereby providing high molecular mobility. Therefore, the glass transition point Tg of the crosslinked polymer alone can be relatively high. However, when the glass transition point of a crosslinked polymer is excessively high, the molecular mobility may not be sufficiently improved even after being mixed with a plasticizer.

Therefore, the glass transition point of the crosslinked polymer may be 400° C. or lower, 350° C. or lower, 300° C. or lower, or 250° C. or lower. The crosslinked polymer may have more than one glass transition point. When the crosslinked polymer has more than one glass transition point, the lowest glass transition point may be within the operating temperature range of a battery. When a crosslinked polymer has such a low glass transition point, the crosslinked polymer in combination with a plasticizer can maintain a high molecular mobility during the operation of a resulting proton-conducting membrane, thereby obtaining a high proton conductivity.

The structure of the main chain of the crosslinked polymer may be arbitrary. For example, the crosslinked polymer may be a vinyl polymer including a crosslinked structure, an ester polymer including a crosslinked structure, an amide polymer including a crosslinked structure, a silicone polymer including a crosslinked structure, or the like. The method of manufacturing each polymer and the method of forming the crosslinked structure may be known. Among the above-described crosslinked polymers, a vinyl polymer including a crosslinked structure is preferable due to excellent availability of monomers and ease of molecular modification. Some or all of the hydrogen atoms of the crosslinked polymer may be substituted with fluorine atoms, and it is preferable that the hydrogen atoms of the crosslinked polymer are not substituted with fluorine for the affinity with a plasticizer such as sulfuric acid.

Herein, the crosslinked polymer may be, for example, a polymer of a first monomer, which is a monomer containing a proton-donating group, or a copolymer of a first monomer, which is a monomer containing a proton-donating group, and a second monomer, which is crosslinkable. The crosslinked polymer may optionally be a copolymer with an additional third monomer, together with the first monomer and the second monomer. Examples of the first, second, and third polymers are described below.

(First Monomer)

The first monomer is a monomer containing a proton-donating group, and for example, may be a monomer containing one or more proton-donating groups and one or more polymerizable groups, and in particular may be a monomer containing one proton-donating group and one polymerizable group. More specifically, the first monomer may be a vinyl monomer containing a proton-donating group. Specific examples of these vinyl monomers containing a proton-donating group include, but are not limited to, the following.

A vinyl monomer containing a sulfonic acid group: styrene sulfonic acid, vinyl sulfonic acid, arylsulfonic acid, 2-acrylamido-2-methyl-1-propanesulfonic acid, 2-(methacryloyloxy)ethanesulfonic acid, or the like;

A vinyl monomer containing a phosphonic acid group: styrene phosphonic acid, vinyl phosphonic acid, allyl phosphonic acid, (4-ethenylphenyl)methane phosphonic acid, 3-(methacryloyloxy)propyl phosphonic acid, or the like; and

A vinyl monomer containing a carboxylic acid group: (meth) acrylic acid, vinyl benzoic acid, or the like.

(Second Monomer)

The second monomer is a crosslinkable monomer, which may be, for example, a monomer containing two or more polymerizable groups, or in particular, a monomer containing two polymerizable groups.

The second monomer may be, for example, a vinyl monomer, and more specific examples thereof include, but are not limited to, divinylbenzene, vinyl (meth)acrylate, allyl (meth)acrylate, 1,6-hexadiene, N,N′-methylenebisacrylamide, diallyl ether, or the like.

(Third Monomer)

The third monomer is a monomer other than the first monomer and the second monomer, and for example, may be a non-crosslinkable monomer containing one polymerizable group and which does not comprise a proton-donating group.

The third monomer may be, for example, a vinyl monomer, and may be, for example, (meth)acrylic acid ester, styrene and a derivative thereof, a conjugated diene, and the like. More specific examples of the third monomer include, but are not limited to, methyl (meth)acrylate, ethyl (meth)acrylate, 2-(2-ethoxyethoxy)ethyl (meth)acrylate, styrene, α-methylstyrene, butadiene, isoprene, or the like.

(Copolymerization Proportion of Each Monomer)

The copolymerization proportion of each monomer in the crosslinked polymer of the present disclosure is arbitrary.

When the total of the monomers constituting the crosslinked polymer is 100 parts by mass, the proportion of the first monomer may be, for example, 5.0 parts by mass or more, 10 parts by mass or more, 15 parts by mass or more, 20 parts by mass or more, 25 parts by mass or more, 30 parts by mass or more, 35 parts by mass or more, 40 parts by mass or more, 45 parts by mass or more, 50 parts by mass or more, 55 parts by mass or more, 60 parts by mass or more, 65 parts by mass or more, 70 parts by mass or more, 75 parts by mass or more, 80 parts by mass or more, 85 parts by mass or more, 90 parts by mass or more, 95 parts by mass or more, 97 parts by mass or more, or 99 parts by mass or more, and may be 100 parts by mass or less.

In the case of using the second monomer, when the total of the first monomer and the second monomer is 100 parts by mass, the amount of the second monomer may be, for example, 0.1 part by mass or more, 0.5 parts by mass or more, 1.0 part by mass or more, 1.5 parts by mass or more, 2.0 parts by mass or more, or 2.5 parts by mass or more, and may be 5.0 parts by mass or less, 4.5 parts by mass or less, 4.0 parts by mass or less, 3.5 parts by mass or less, 3.0 parts by mass or less, or 2.5 parts by mass or less. Note that in place of the second monomer or in addition to the second monomer, a crosslinking agent or the like can be appropriately added to form a crosslink. The content of the crosslinking agent when a crosslinking agent is used in place of the second monomer, and the content of the total of the second monomer and the crosslinking agent when both are used in combination, are not particularly limited and may be the same as the amount of the second monomer listed above.

In the case of using the third monomer, when the total of the first, second, and third monomers is 100 parts by mass, the amount of the third monomer may be, for example, 0.1 parts by mass or more, 0.5 parts by mass or more, 1.0 parts by mass or more, 1.5 parts by mass or more, 2.0 parts by mass or more, or 2.5 parts by mass or more, and may be 50 parts by mass or less, 40 parts by mass or less, 30 parts by mass or less, 20 parts by mass or less, 15 parts by mass or less, 10 parts by mass or less, 5.0 parts by mass or less, or 1.0 part by mass or less. The third monomer may not be used.

Herein, “parts by mass” and “mass %” are merely different in expression and are to be treated as synonymous unless otherwise noted. For example, the phrase “when the total is 100 parts by mass, the amount of component X is x parts by mass” is synonymous with the phrase “when the total is 100 mass %, the amount of component X is x mass %.

(Polymerization of Crosslinked Polymer)

Copolymers of the first to third monomers can be obtained by a known method of polymerization, such as a radical polymerization method, a cationic polymerization method, or an anionic polymerization method, and preferably by a radical polymerization method.

Radical polymerization may be carried out by bringing a predetermined mixture of monomers into contact with a radical polymerization initiator. Radical polymerization may be carried out in the presence of a plasticizer as described below.

The radical polymerization initiator may be selected, for example, from an azo compound, hydrogen peroxide, an organic peroxide, and the like. The azo compound may be selected, for example, from azobisisobutyronitrile, 1,1′-azobis(cyclohexane-1-carbonitrile), 2,2′-azobis(4-methoxy-2,4-dimethylvaleronitrile), and the like. The organic peroxide may be selected from, for example, benzoyl peroxide, diisobutyl peroxide, and the like.

The proportion of radical polymerization initiator used, relative to the total 100 parts by mass of the monomers, may be, for example, 0.001 part by mass or more, 0.01 part by mass or more, 0.1 part by mass or more, or 0.2 parts by mass or more, and may be 3.0 parts by mass or less, 2.0 parts by mass or less, 1.0 part by mass or less, 0.5 parts by mass or less, or 0.3 parts by mass or less.

Radical polymerization may be carried out under solvent-free conditions, or optionally in an appropriate solvent. The solvent may be selected from water and organic solvents. A mixture of two or more solvents may be used as a solvent for radical polymerization.

The organic solvent may be a polar organic solvent, for example, an alcohol such as methanol; an ether such as diethyl ether or tetrahydrofuran; a ketone such as acetone; an amide compound such as N,N-dimethylformamide; or a nitrile compound such as acetonitrile. The plasticizer described below may be used as part or all of the solvent for radical polymerization.

The proportion of solvent used may be arbitrary. However, for example, a range of from 10 to 1,000 parts by mass relative to the total 100 parts by mass of the monomers may be used as an example of the solvent usage proportion.

Radical polymerization can be carried out, for example, at a temperature of 40° C. or higher, 50° C. or higher, 60° C. or higher, 70° C. or higher, or 80° C. or higher, and at a temperature of 200° C. or lower, 150° C. or lower, 120° C. or lower, or 100° C. or lower, for example, for a period of 30 minutes or longer, 1 hour or longer, 2 hours or longer, 3 hours or longer, 5 hours or longer, or 7 hours or longer, and for a period of 10 hours or shorter, 8 hours or shorter, 5 hours or shorter, or 3 hours or shorter.

After polymerization, the resulting polymer may be purified by an appropriate method to remove unreacted monomers, low-molecular-weight oligomers, radical initiator residues, and the like. The purification method may be solvent replacement, reprecipitation, or the like.

<Plasticizer>

The proton-conducting membrane of the present disclosure contains a plasticizer. In the present disclosure, at least 60 mass % of the plasticizer is a proton-donating compound with a pKa of 2.5 or less.

Herein, the plasticizer may be a component with a function such as imparting flexibility to the crosslinked polymer, lowering the glass transition point Tg of the proton-conducting membrane, or increasing the molecular mobility of the crosslinked polymer in the proton-conducting membrane. The plasticizer is preferably non-volatile in the operating temperature range of a battery (for example, from −40° C. or higher to less than 200° C., typically from 0° C. to 150° C.). The fact that a plasticizer is non-volatile in the operating temperature range of a battery means that the boiling point of the plasticizer is sufficiently high, for example, above 150° C., 200° C. or higher, 210° C. or higher, 220° C. or higher, 230° C. or higher, 240° C. or higher, or 250° C. or higher. It is desirable that a plasticizer does not decompose in the operating temperature range of a battery. The plasticizer is desired to be liquid in the operating temperature range of a battery in order to exhibit a function of improving the molecular mobility of a crosslinked polymer in a proton-conducting membrane. The fact that a plasticizer is liquid in the operating temperature range of a battery means that the melting point of the plasticizer is, for example, 0° C. or less, −2° C. or less, −4° C. or less, or −6° C. or less.

Herein, the proton-donating compound used in the plasticizer may have a pKa of 2.5 or less, a pKa of 2.3 or less, a pKa of 2.1 or less, a pKa of 2.0 or less, a pKa of 1.0 or less, a pKa of 0.0 or less, a pKa of −1.0 or less, or a pKa of −2.0 or less. Therefore, the plasticizer contains a proton-donating compound with high acidity, i.e., contains a compound with a high tendency to release protons. Note that when the proton-donating compound is a polybasic acid, this pKa means pKa1.

Herein, the plasticizer may be composed only of a proton-donating compound with a pKa of 2.5 or less, or may be composed of a proton-donating compound and another plasticizer. From the viewpoint of further exhibiting the effect of the present disclosure, it is preferable that there are more proton-donating compounds with a pKa of 2.5 or less contained in a plasticizer. Accordingly, at least 60 mass %, at least 65 mass %, at least 70 mass %, at least 80 mass %, at least 90 mass %, or substantially 100 mass % of the plasticizer may be a proton-donating compound with a pKa of 2.5 or less.

Herein, the proton-donating compound may be a compound containing one or more groups selected from a sulfuric acid group, a sulfonic acid group, a phosphoric acid group, and a phosphonic acid group. Note that the pKa (pKa1) of sulfuric acid is about −3.0, the pKa of methanesulfonic acid is about −1.9, the pKa (pKa1) of phosphoric acid is about 2.1, and the pKa (pKa1) of phosphonic acid is about 1.5.

Herein, the proton-donating compound preferably has a boiling point or decomposition temperature that is high enough that the proton-donating compound does not evaporate or decompose in the operating temperature range of the battery. From this viewpoint, the boiling point or decomposition temperature of the proton-donating compound may be, for example, 150° C. or higher, or 200° C. or higher.

The proton-donating compound may be, more specifically, one or more selected from, for example, sulfuric acid and phosphoric acid, or may be sulfuric acid, phosphoric acid, or a mixture thereof. Note that the boiling point of sulfuric acid is about 290° C. (decomposition), and the boiling point of phosphoric acid is about 213° C. (decomposition).

The other plasticizer may be a plasticizer containing no proton-donating properties, and may be, for example, a polyalkylene glycol, polyvinyl ether, polyol ester, or the like. When the total amount of the plasticizer is 100 parts by mass, the proportion of the other plasticizer used may be, for example, 50 parts by mass or less, 30 parts by mass or less, 10 parts by mass or less, 5 parts by mass or less, or 1 part by mass or less, or the other plasticizer may not be used at all.

(Molar Ratio of Plasticizer Relative to Repeating Unit Containing Proton-Donating Group)

Herein, the molar ratio of the plasticizer to the repeating unit containing a proton-donating group (plasticizer/repeating unit containing a proton-donating group) is not particularly limited, and may be, for example, 0.2 or more, 0.3 or more, 0.4 or more, 0.5 or more, 0.6 or more, 0.7 or more, 0.8 or more, 0.9 or more, 1.0 or more, 1.1 or more, 1.2 or more, 1.3 or more, 1.4 or more, 1.5 or more, 1.6 or more, 1.7 or more, 1.8 or more, 1.9 or more, 2.0 or more, 2.5 or more, 3.0 or more, 3.5 or more, 4.0 or more, 4.5 or more, 5.0 or more, 5.5 or more, 6.0 or more, 6.5 or more, 7.0 or more, or 7.5 or more, and may be 10 or less, 9.0 or less, or 8.0 or less. This molar ratio is, for example, preferably 1.0 or higher from the viewpoint of improving proton conductivity, or preferably 8.0 or less from the viewpoint of preventing bleeding out of a plasticizer.

(Proportion of Crosslinked Polymer and Plasticizer)

The proportion of the crosslinked polymer and the plasticizer used is not particularly limited, and when the total of the crosslinked polymer and the plasticizer is 100 parts by mass, the content of the plasticizer may be, for example, 20 parts by mass or more, 30 parts by mass or more, 40 parts by mass or more, 50 parts by mass or more, 60 parts by mass or more, 70 parts by mass or more, or 80 parts by mass or more, and may be 90 parts by mass or less, 85 parts by mass or less, or 80 parts by mass or less. From the viewpoint of improving the proton conductivity, the content of the plasticizer is preferably 50 parts by mass or more when the total of the crosslinked polymer and the plasticizer is 100 parts by mass, and from the viewpoint of preventing bleeding out of the plasticizer, the content of the plasticizer is preferably 90 parts by mass or less when the total of the crosslinked polymer and the plasticizer is 100 parts by mass.

<Properties of Proton-Conducting Membrane>

(Proton Conductivity)

The proton-conducting membrane of the present disclosure exhibits a high proton conductivity in low-humidity or anhydrous environments. More specifically, for example, the proton-conducting membrane of the present disclosure can exhibit the following proton conductivities.

The proton conductivity of the proton-conducting membrane of the present disclosure at 50° C. may be 0.00048 S/cm or more, 0.001 S/cm or more, 0.010 S/cm or more, 0.020 S/cm or more, 0.023 S/cm or more, 0.025 S/cm or more, 0.030 S/cm or more, 0.040 S/cm or more, 0.050 S/cm or more, 0.055 S/cm or more, 0.080 S/cm or more, 0.100 S/cm or more, or 0.110 S/cm or more.

The proton conductivity of the proton-conducting membrane of the present disclosure at 80° C. may be 0.0018 S/cm or more, 0.010 S/cm or more, 0.020 S/cm or more, 0.030 S/cm or more, 0.040 S/cm or more, 0.050 S/cm or more, 0.080 S/cm or more, 0.100 S/cm or more, 0.110 S/cm or more, 0.150 S/cm or more, or 0.180 S/cm or more.

The proton conductivity of the proton-conducting membrane of the present disclosure at 120° C. may be 0.0051 S/cm or more, 0.010 S/cm or more, 0.050 S/cm or more, 0.060 S/cm or more, 0.061 S/cm or more, 0.080 S/cm or more, 0.086 S/cm or more, 0.100 S/cm or more, 0.160 S/cm or more, 0.200 S/cm or more, or 0.250 S/cm or more.

(Water Content)

The proton-conducting membrane of the present disclosure exhibits a high proton conductivity even when no water is contained in the membrane. Therefore, when the total mass of the membrane is 100 parts by mass, the water content of the proton-conducting membrane may be, for example, 10 parts by mass or less, 5 parts by mass or less, 1 part by mass or less, 0.1 part by mass or less, 0.01 part by mass or less, or 0.001 part by mass or less.

<<Method of Manufacturing Proton-Conducting Membrane>>

In the proton-conducting membrane of the present disclosure, the crosslinked polymer and the plasticizer are in a mixed state.

The proton-conducting membrane of the present disclosure may be produced, for example, by impregnating a crosslinked polymer with a plasticizer. This may be carried out in a suitable solvent with high volatility. The solvent used here may be selected from those listed above as a polymerization solvent for the crosslinked polymer. After impregnating the crosslinked polymer with the plasticizer together with the solvent, the proton-conducting membrane of the present disclosure may be obtained by removing the solvent.

The proton-conducting membrane of the present disclosure may also be produced by polymerizing a crosslinked polymer in the presence of a plasticizer and then removing a polymerization solvent. In this case, it is preferable to use a step to remove unreacted monomers, low-molecular-weight oligomers, radical initiator residues, and the like by an appropriate method, such as solvent replacement or reprecipitation.

The formation of the proton-conducting membrane into a membrane shape may be carried out by an appropriate method, such as casting or pressing.

<<Fuel Cell>>

The fuel cell of the present disclosure comprises the proton-conductive membrane of the present disclosure. In particular, the fuel cell of the present disclosure comprises a laminate comprising a fuel electrode side separator having a fuel flow path, a fuel electrode side catalyst layer, the proton-conductive membrane of the present disclosure, an air electrode side catalyst layer, and an air electrode side separator having an air flow path laminated in this order. More specifically, the fuel cell of the present disclosure comprises a laminate comprising a fuel electrode side separator having a fuel flow path, a fuel electrode side gas diffusion layer, a fuel electrode side catalyst layer, the proton-conductive membrane of the present disclosure, the air electrode side catalyst layer, the air electrode side gas diffusion layer, and the air electrode side separator having an air flow path laminated in this order.

### EXAMPLES

Examples are given below to further describe the present disclosure, but the present disclosure is not limited thereto.

### Example 1

### Preparation of Proton-Conducting Membrane of Example 1

In Example 1, according to Schemes 1 and 2 below, a styrene sulfonic acid n-butyl monomer with an esterified proton-donating group was synthesized (the first step), the synthesized n-butyl styrene sulfonate monomer was copolymerized with divinylbenzene which was a bifunctional vinyl monomer to synthesize a crosslinked polymer (the second step), and an ester protecting group of the crosslinked polymer was deprotected by hydrolysis to synthesize a crosslinked polymer membrane (hereinafter, also referred to as “CL-SS membrane”) containing almost 100 mol % of styrene sulfonic acid with a proton-donating group as a monomer unit (assuming 100 mol % of styrene sulfonic acid as a monomer unit, the equivalent mass EW was equivalent to 184) (the third step). This CL-SS was swollen with sulfuric acid (also referred to as “H₂SO₄”), which is a plasticizer, to prepare the anhydrous proton-conducting membrane of Example 1 (hereinafter, also referred to as “CL-SS/H₂SO₄ membrane”) (the fourth step).

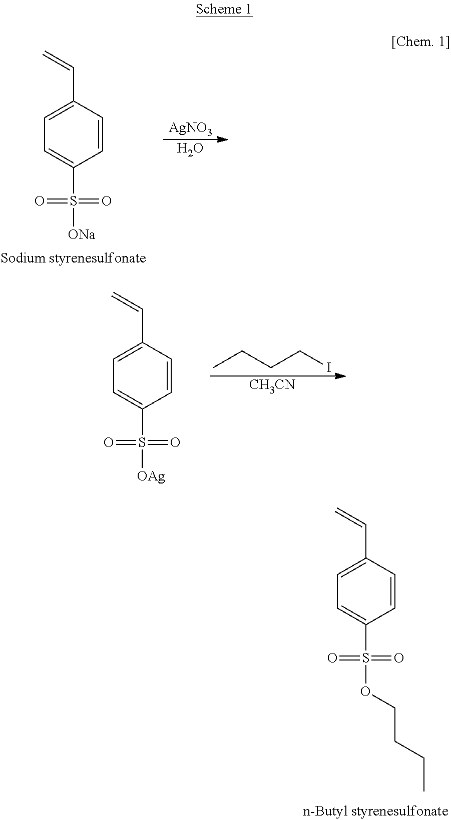

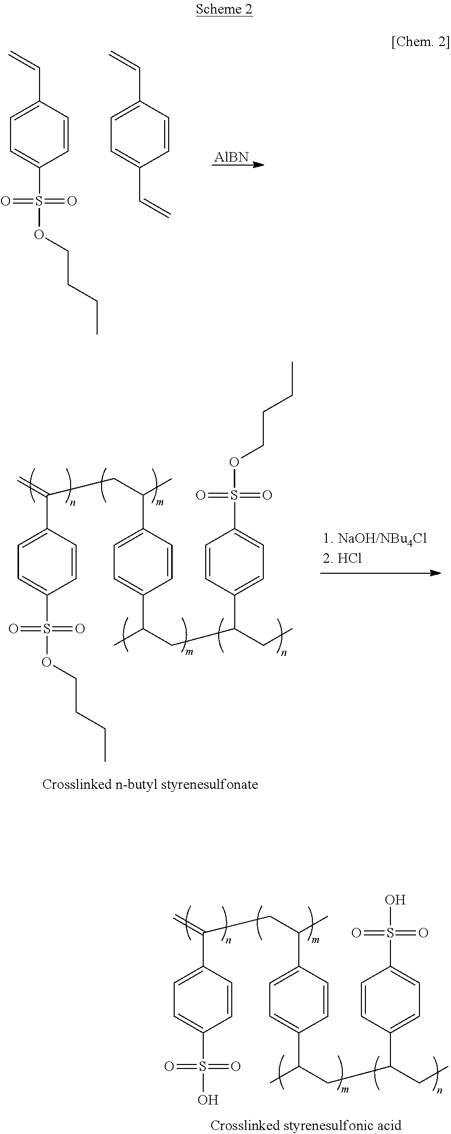

(First Step)

Step 1-1

10.0 g (48.5 mmol) of sodium styrene sulfonate, a precursor of n-butyl styrene sulfonate monomer, was weighed and placed in a 500-mL eggplant flask shielded from light by aluminum foil, dissolved in 100 mL of distilled water, and immersed in an ice bath. An aqueous silver nitrate (I) solution prepared by dissolving 9.06 g (53.3 mmol) of silver nitrate (I) in 20 mL of distilled water was gradually dropped into the reaction vessel, in which stirring was carried out in an ice bath. After stirring at 0° C. for 2 hours, suction filtration and washing with distilled water, followed by washing with diethyl ether, yielded a white solid crude product. Note that since this crude product is decomposed by light, experimental operations were carried out in a place that was as dark as possible.

The above-described crude product was purified by dissolving in 300 mL of acetonitrile and removing insoluble impurities by filtration. The volatile solvent (acetonitrile) was removed under reduced pressure from the acetonitrile solution in which the product was dissolved, and the volatile solvent was further removed by drying at 40° C. for about 3 hours using a vacuum dryer to obtain 12.3 g (42.3 mmol, 87% yield) of silver styrene sulfonate (I) as a powdery yellowish-white solid.

Step 1-2

5.00 g (17.2 mmol) of silver (I) styrene sulfonate obtained in the above-described Step 1-1 was added to a 500-mL cocked two-necked eggplant flask shielded from light by aluminum foil, and nitrogen substitution was performed to create a nitrogen atmosphere in a reaction container. 40 mL of acetonitrile as a solvent was added to the reaction container using a syringe, and silver styrene sulfonate (I) was dissolved by stirring. To this reaction solution, 2.37 mL (20.9 mmol) of 1-iodobutane was gradually added dropwise using a syringe, and the mixture was stirred at room temperature for about 2 days. The reaction solution was filtered to remove silver iodide (I), a byproduct, and the volatile solvent (acetonitrile) was removed under reduced pressure to obtain a yellow oily crude product.

Water-soluble impurities were removed from the above-described crude product by separation of distilled water and diethyl ether. The diethyl ether solution of the product was dehydrated using anhydrous magnesium sulfate and filtered to remove water and solid impurities such as magnesium sulfate. After removal of the volatile solvent (diethyl ether) under reduced pressure, 2.94 g (12.2 mmol, 71% yield) of n-butyl styrene sulfonate monomer was obtained as an oily colorless liquid by separation and purification by column chromatography (development solvent:chloroform) using silica gel.

A solution of about 1 mass % was prepared by dissolving n-butyl styrene sulfonate in heavy chloroform, and the product was attributed by ¹H-NMR. A signal attributed to the target product, n-butyl styrene sulfonate monomer, was observed at 6=0.87, 1.34, 1.62, 4.05, 5.48, 5.93, 6.74, 7.57, 7.85, and it was confirmed that the product was n-butyl styrene sulfonate monomer.

(Second Step)

Each monomer was purified by passing unpurified styrene sulfonic acid n-butyl monomer and divinylbenzene through a column packed with basic alumina, respectively. The purified styrene sulfonic acid n-butyl monomerand divinylbenzene, and azobisisobutyronitrile (AIBN) were each weighed out in 1.00 g (4.16 mmol), 5.47 mg (42.0 μmol), 2.7 mg (16.6 μmol), and a solution was prepared by mixing them in a 50-mL sample bottle. The mass ratio of n-butyl styrene sulfonate monomer, divinylbenzene, and AIBN in the raw material solution was approximately 250:2.5:1 (n-butyl styrene sulfonate monomer:divinylbenzene:AIBN). When the polymerization proceeds in accordance with the monomer preparation ratio, the proportion (mol %) of n-butyl styrene sulfonate repeating units among the repeating units constituting the resulting crosslinked polymer is theoretically about 99 mol %, as determined by the following Formula (1).

Proportion of n-butyl styrene sulfonate repeating units (mol %)=[moles of n-butyl styrene sulfonate monomer/(sum of moles of n-butyl styrene sulfonate and moles of divinylbenzene monomer)]×100 (1)

After sealing with a rubber septum, the solution was bubbled with nitrogen gas for 20 minutes, and polymerization was carried out at 80° C. using an oil bath at ambient pressure. After 7 hours, the polymerization reaction was stopped by leaving the sample bottle at room temperature, and the resulting crude product was a glassy membrane.

The above-described crude product was removed from the sample bottle, immersed in tetrahydrofuran (THF), allowed to stand still for 2 hours, and then the THF used for the immersion was removed. The operation of immersion in THF was carried out three times in total, and unreacted monomers, low-molecular oligomers, and uncrosslinked polymers were removed and purified. The crosslinked n-butyl styrenesulfonate polymer was obtained by leaving the purified product to stand still at 50° C. for 4 hours to remove the volatile solvent (THF).

(Third Step)

5.00 g (124 mmol) of sodium hydroxide and 3.47 g (12.5 mmol) of tetrabutylammonium chloride were dissolved in a mixed solvent composed of 27 mL of THF and 3 mL of water to prepare a basic solution with an interface between THF and water. 30 mL of this basic solution was poured into a 50-mL sample bottle, and about 1.0 g of the crosslinked polymer obtained in the first step was immersed therein, and the deprotection reaction by hydrolysis was carried out at 50° C. for 72 hours. When the deprotection reaction proceeds suitably, the proportion of styrene sulfonic acid among the repeating units of the resulting crosslinked polymer was about 99 mol %.

The above-described crosslinked polymer was removed from the sample bottle, immersed in water, and allowed to stand still for 2 hours, and then the water used for immersion was removed. The water immersion operation was carried out twice in total to remove residual sodium hydroxide and tetrabutylammonium chloride from the crosslinked polymer. Then, the polymer was immersed in hydrochloric acid with a concentration of 1M and allowed to stand still for 24 hours, and then the hydrochloric acid used for immersion was removed. After immersion in deionized water for 2 hours, the deionized water used for immersion was removed three times. The water was removed by leaving the polymer to stand still at 50° C. for 4 hours and then drying in a vacuum dryer for about 1 day to remove the water. The sodium ions in the crosslinked polymer were exchanged with protons by this operation, and the excess hydrochloric acid was removed to synthesize 0.78 g of CL-SS membrane.

(Fourth Step)

A solution composed of 0.148 g of concentrated sulfuric acid (97%) and 1.51 g of methanol was poured into a PTFE (polytetrafluoroethylene) container (inner diameter: 4.3 cm), and 0.0370 g of CL-SS membrane was immersed in the solution, and allowed to stand still at 50° C. for about 2 days to evaporate the volatile solvent (methanol). Then, the volatile solvent was removed by drying at 50° C. for about one day using a vacuum dryer, and the CL-SS membrane was swollen with H₂SO₄ to obtain a 0.185 g CL-SS/H₂SO₄ membrane (thickness: 1.17 mm) as the proton-conducting membrane of Example 1.

In the proton-conducting membrane of Example 1, the mass ratio of CL-SS to H₂SO₄ was 20:80, and the molar ratio of H₂SO₄ (plasticizer) to the repeating unit containing a sulfonic acid group (i.e. proton-donating group) was 7.6, as determined by the following Formula (2).

Molar ratio of H₂SO₄ relative to repeating units containing sulfonic acid groups=Moles of H₂SO₄/Moles of styrene sulfonic acid monomer units in crosslinked polymer (2)

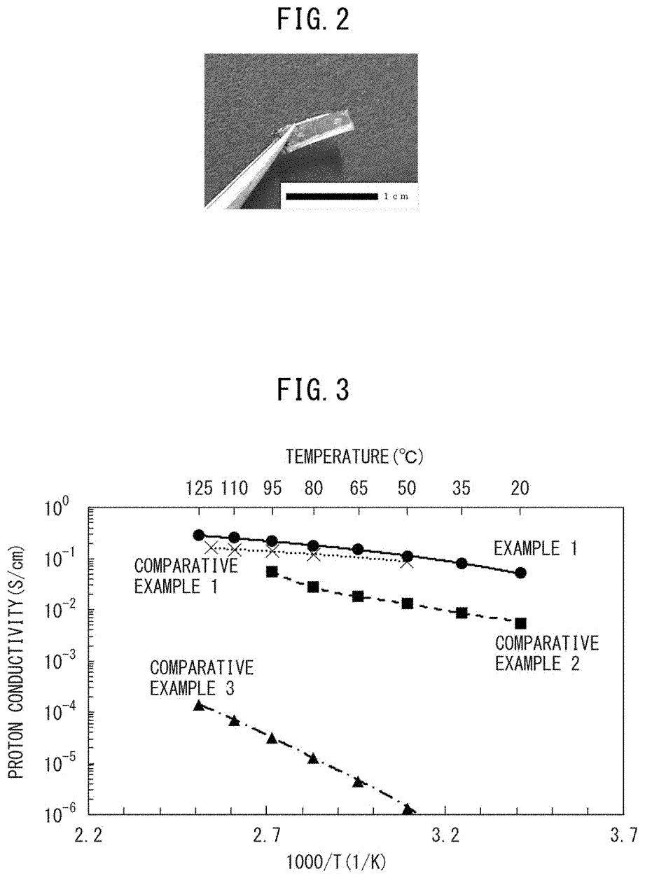

A photograph of the proton-conducting membrane obtained in Example 1 is illustrated in FIG. 2. The proton-conducting membrane was self-standing, as shown in FIG. 2.

The proton conductivity of the sample of this proton-conducting membrane was determined by the following Formula (3) was 0.28 S/cm (280 mS/cm), exhibiting extremely high proton conductivity even under non-humidified conditions.

Proton conductivity=Distance between electrodes/(Thickness of membrane×Width of membrane×Resistance value) (3)

Then, AC impedance measurement was carried out under the measurement conditions of a temperature of 110° C. and a relative humidity of practically 0% RH, and the resistance value of the measurement sample read from the intercept of the X-axis of the Nyquist plot was 49Ω, and the proton conductivity was as high as 0.25 S/cm (250 mS/cm).

AC impedance measurement was carried out under the measurement conditions of a temperature of 95° C. and a relative humidity of 2.5% RH, and the resistance value of the measurement sample read from the intercept of the X-axis of the Nyquist plot was 55Ω, and the proton conductivity was as high as 0.22 S/cm (220 mS/cm).

AC impedance measurement was carried out under the measurement conditions of a temperature of 80° C. and a relative humidity of 2.7% RH, and the resistance value of the measurement sample read from the intercept of the X-axis of the Nyquist plot was 67Ω, and the proton conductivity was as high as 0.18 S/cm (180 mS/cm).

AC impedance measurement was carried out under the measurement conditions of a temperature of 65° C. and a relative humidity of 3.0% RH, and the resistance value of the measurement sample read from the intercept of the X-axis of the Nyquist plot was 84Ω, and the proton conductivity was as high as 0.15 S/cm (150 mS/cm).

AC impedance measurement was carried out under the measurement conditions of a temperature of 50° C. and a relative humidity of 3.5% RH, and the resistance value of the measurement sample read from the intercept of the X-axis of the Nyquist plot was 1.1×10²Ω, and the proton conductivity was as high as 0.11 S/cm (110 mS/cm).

AC impedance measurement was carried out under the measurement conditions of a temperature of 35° C. and a relative humidity of 4.2% RH, and the resistance value of the measurement sample read from the intercept of the X-axis of the Nyquist plot was 1.6×10²Ω, and the proton conductivity was 0.079 S/cm (79 mS/cm).

AC impedance measurement was carried out under the measurement conditions of a temperature of 20° C. and a relative humidity of 5.1% RH, and the resistance value of the measurement sample read from the intercept of the X-axis of the Nyquist plot was 2.4×10²Ω, and the proton conductivity was 0.052 S/cm (52 mS/cm).

The measurement results of the proton conductivity of Example 1 are shown in Table 1 below and FIG. 3, and are represented in FIG. 3 by the black filled circle (●) plot points and a solid line connecting them.

As shown in FIG. 3, the proton conductivity of the proton-conducting membrane of Example 1 tended to increase with increasing temperature. This may be due to the increase in the molecular mobility of the proton-conducting mixed phase in a quasi-fluid state with increasing temperature, resulting in improvement of proton conductivity.

### Comparative Example 1

The proton-conducting membrane of Comparative Example 1 is prepared by synthesizing a crosslinked polymer membrane monomer (hereinafter, also referred to as “CL-P membrane”) containing a basic functional group (proton-accepting group) in place of the proton-donating group by copolymerizing a 4-vinylpyridine monomer and N,N′-methylenebisacrylamide which was a bifunctional vinyl, and then the membrane (also referred to as “CL-P/H₂SO₄ membrane”) was prepared by swelling the CL-P membrane with H₂SO₄, a plasticizer, and the CL-P/H₂SO₄ membrane was the same as the proton-conducting membrane disclosed in Example 1 of PTL 1.

The proton conductivity of Comparative Example 1 under non-humidified conditions (thickness: 0.13 mm) was measured in the same manner as in Example 1, and the results are shown in Table 1 and FIG. 3, and are represented in FIG. 3 by plot points marked with X and a dotted line connecting them. The proton conductivity at 120° C. was measured with a relative humidity of practically 0% RH.

The mass ratio of CL-P to H₂SO₄ was 18:82, and the molar ratio of H₂SO₄ to repeating units containing pyridyl groups was 5.0, as determined by the following Formula (4).

Molar ratio of H₂SO₄ to repeating units containing pyridyl groups=Moles of H₂SO₄/Moles of 4-vinylpyridine monomer units in crosslinked polymer (4)

Under non-humidified conditions and in the temperature range of from 50 to 120° C., the membrane of Comparative Example 1, for example, had a conductivity of 0.14 S/cm (140 mS/cm) at 95° C., and the proton-conducting membrane of Example 1 was found to exhibit higher proton conductivity than the proton-conducting membrane of Comparative Example 1. This is because that, in Comparative Example 1, the equimolar amount with the basic functional groups (proton-accepting functional groups) of the H₂SO₄ molecules were consumed for the formation of an ionic complex, and therefore, the equimolar amount with the basic functional groups of H₂SO₄ molecules cannot contribute to proton conduction, one the other hand, in Example 1, since CL-SS does not contain basic functional groups, almost all of the H₂SO₄ molecules penetrated into CL-SS contribute as a free proton source involved in proton transport, and therefore, high proton conductivity was exhibited.

### Comparative Example 2

In Comparative Example 2, Nafion (registered trademark, NR212, Aldrich) was used in place of CL-SS, not swollen with H₂SO₄, and under humidified conditions (relative humidity 90% RH).

AC impedance measurement was carried out in the same manner as in Example 1 except for the humidified conditions (relative humidity 90% RH), and the proton conductivity of the proton-conducting membrane of Comparative Example 2 was measured.

The measurement results are shown in Table 1 and FIG. 3, and are represented by black rectangle (▪) plot points and a dashed line in FIG. 3. Under humidified conditions and in the temperature range of from 20 to 95° C., the membrane of Comparative Example 2, for example, exhibited a proton conductivity of 0.054 S/cm (54 mS/cm) at 95° C. The proton-conducting membrane of Example 1 was found to exhibit higher proton conductivity under non-humidified conditions compared to the proton-conducting membrane of Comparative Example 2 under humidified conditions.

### Comparative Example 3

In Comparative Example 3, Nafion (registered trademark, NR212, Aldrich) was used in place of CL-SS, not swollen with H₂SO₄, and under non-humidified conditions.

AC impedance measurements were performed in the same manner as in Example 1, and the proton conductivity of the proton-conducting membrane of Comparative Example 3 was measured.

The measurement results are shown in Table 1 and FIG. 3, and are represented in FIG. 3 by black triangle (▴) plot points and a long chain line.

Under non-humidified conditions and in the temperature range of from 20 to 125° C., the membrane of Comparative Example 3 was found to exhibit a considerably low proton conductivity of, for example, 0.00015 S/cm (0.15 mS/cm) at 125° C.

### Comparative Example 4

In Comparative Example 4, Nafion (registered trademark, NR212, Aldrich) was used, and the membranes were swollen with H₂SO₄ by the same method as in Example 1, and the proton conductivity measurements were carried out under non-humidified conditions.

Attempts were made to introduce as much H₂SO₄ as possible into the Nafion, but Nafion has many water-repellent moieties, and the maximum amount of H₂SO₄ that could be introduced was 15 mass %, in other words, the mass ratio of Nafion membrane to H₂SO₄ was 85:15, and most of the H₂SO₄ that was attempted to be mixed in was repelled on the membrane, and therefore wiped off. In this membrane, the molar ratio of H₂SO₄ to repeating units containing sulfonic acid groups was 0.52, as determined by the following Formula (5).

Molar ratio of H₂SO₄ to repeating units containing sulfonic acid groups=Moles of H₂SO₄/(Acid capacity of Nafion, 0.92 meq/g×Weight of Nafion membrane) (5)

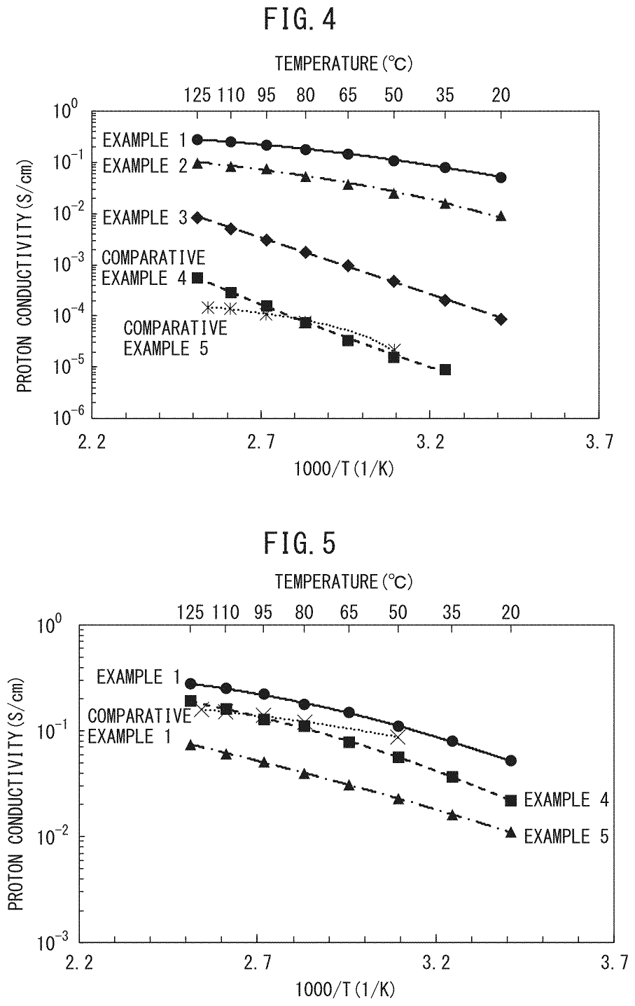

AC impedance measurements were performed in the same manner as in Example 1 to measure the proton conductivity under non-humidified conditions. The measurement results are shown in Table 1 and FIG. 4, and are represented in FIG. 4 by black rectangle (▪) plot points and a dashed line connecting them. For comparison, FIG. 4 also shows the proton conductivity results of Example 1.

Under non-humidified conditions and in the temperature range of from 20 to 125° C., the proton-conducting membrane of Comparative Example 4 was found to exhibit a considerably low proton conductivity of, for example, 0.00057 S/cm (0.57 mS/cm) at 125° C.

### Example 2

In Example 2, the same CL-SS membrane as in Example 1 was used, and the proton-conducting membrane (0.11 cm) was prepared by swelling the CL-SS membrane with H₂SO₄ in the same manner as in Example 1, except that the amounts of H₂SO₄ and methanol used were changed accordingly. In the proton-conducting membrane of Example 2, the mass ratio of CL-SS to H₂SO₄ was 50:50, and the molar ratio of H₂SO₄ (plasticizer) to the repeating unit containing a sulfonic acid group (i.e. proton-donating group) was 1.9, as determined by the above-described Formula (2).

AC impedance measurements were performed in the same manner as in Example 1 to measure the proton conductivity under non-humidified conditions. The measurement results are shown in Table 1 and FIG. 4. In FIG. 4, the results are represented by black triangle (▴) plot points and a long chain line connecting them.

It was found that the proton-conducting membrane of Example 2 exhibited a proton conductivity of from 0.0094 to 0.10 S/cm (from 9.4 to 100 mS/cm) under non-humidified conditions and in the temperature range of from 20 to 125° C. It was found that the proton-conducting membrane of Example 2 exhibited a high proton conductivity comparable to that of Comparative Example 1, even though the amount of H₂SO₄ introduced was small.

### Comparative Example 5

The membrane of Comparative Example 5 was made of CL-P used in Comparative Example 1, and the mass ratio of CL-P to H₂SO₄ was 45:55, and the molar ratio of H₂SO₄ to repeating units containing pyridyl groups was 1.3, as determined by the above-described Formula (4).

For the membranes of Comparative Example 5, the proton conductivity was measured under non-humidified conditions in the same manner as in Comparative Example 1. The results are shown in Table 1 and FIG. 4, and are represented in FIG. 4 by star (*) plot points and a dotted line connecting them.

Under non-humidified conditions and in the temperature range of from 50 to 120° C., the membrane of Comparative Example 5 exhibited a conductivity of 0.00015 S/cm (0.15 mS/cm) at 120° C., for example. The proton-conducting membrane of Comparative Example 5 was found to be considerably inferior to the proton-conducting membrane of Example 2. This is because, in Comparative Example 5, the equimolar amount of H₂SO₄ formed an ionic complex with the basic functional group (proton-accepting functional group), and most of the permeated H₂SO₄ was consumed, which means that there was almost no H₂SO₄ left to contribute as a free proton source, resulting in a low conductivity. In Example 2, the H₂SO₄ molecules were not consumed, therefore, the number of H₂SO₄ molecules that contribute as a free proton source was increased, and the mobility of the molecules was supposed to be higher, which is why a high conductivity was exhibited.

### Comparative Example 6

In Comparative Example 6, an attempt was made to prepare a proton-conducting membrane by using an uncrosslinked polystyrene sulfonic acid (hereafter, referred to as PSS) in place of CL-SS and mixing with H₂SO₄.

5.56 g of aqueous PSS solution (18 wt %, Aldrich, Mw about 75,000) and 1.00 g of H₂SO₄ were mixed, and the volatile solvent (water) was evaporated by allowing the mixture to stand still at 50° C. for about 1 day. Then, the volatile solvent was removed by drying at 50° C. for about one day using a vacuum dryer to obtain 2.00 g of highly viscous liquid of PSS/H₂SO₄ in which PSS was swollen with H₂SO₄. The mass ratio of PSS to H₂SO₄ was 50:50, and the molar ratio of H₂SO₄ (plasticizer) to repeating units containing sulfonic acid groups (i.e. proton-donating groups) was 1.9, as determined by the above-described Formula (2).

In Comparative Example 6, the membrane could not maintain the shape and could not be used as a proton-conducting membrane because the membrane flowed when allowed to stand still at 50° C. using a vacuum dryer. Not that it was found that in Example 1 or 2, because of the chemical crosslinking the membrane did not flow as in Comparative Example 6, but maintained the shape and could therefore be used as a proton-conducting membrane.

### Example 3

In Example 3, the same CL-SS membrane as in Example 1 was used, and the proton-conducting membrane (0.10 cm) was prepared by swelling the CL-SS membrane with H₂SO₄ in the same manner as in Example 1, except that the amounts of H₂SO₄ and methanol used were changed accordingly. In the proton-conducting membrane of Example 3, the mass ratio of CL-SS to H₂SO₄ was 80:20, and the molar ratio of H₂SO₄ (plasticizer) to the repeating unit containing a sulfonic acid group (i.e. proton-donating group) was 0.48, as determined by the above-described Formula (2).

AC impedance measurements were performed in the same manner as in Example 1 to measure the proton conductivity under non-humidified conditions. The measurement results are shown in Table 1 and FIG. 4, and are represented in FIG. 4 by black rhombus (♦) plot points and a long dashed line connecting them.

It was found that the proton-conducting membrane of Example 3 exhibited a proton conductivity of from 0.000086 to 0.0084 S/cm (from 0.086 to 8.4 mS/cm) under non-humidified conditions and in the temperature range of from 20 to 125° C. It was found that the the proton-conducting electrolyte membrane of Example 3 exhibited a high proton conductivity compared to that of Comparative Example 4, even though the amount of H₂SO₄ introduced was small.

### Example 4

In Example 4, the same CL-SS membrane as in Example 1 was used, and the CL-SS membrane was swollen with H₃PO₄ to prepare the proton-conducting membrane (0.085 cm) in the same manner as in Example 1, except that the plasticizer used was changed to phosphoric acid, a slightly weaker acid than H₂SO₄ (hereinafter, also referred to as “H₃PO₄”), and the amount of methanol was appropriately changed. The mass ratio of CL-SS to H₃PO₄ was 20:80, and the molar ratio of H₃PO₄ (plasticizer) to repeating units containing sulfonic acid groups (i.e. proton-donating groups) was 7.6, as determined by the above-described Formula (2).

AC impedance measurements were carried out in the same manner as in Example 1 to measure the proton conductivity under non-humidified conditions. The measurement results are shown in Table 1 and FIG. 5, and are represented in FIG. 5 by black filled rectangle (▪) plot points and a dashed line connecting them. For comparison, FIG. 5 also shows the proton conductivity results of Example 1 and Comparative Example 1.

Under non-humidified conditions and in the temperature range of from 20 to 125° C., the membrane of Example 4 exhibited a high conductivity of from 0.022 to 0.19 S/cm (from 22 to 190 mS/cm), which was comparable to that of Comparative Example 1 in terms of proton conductivity.

### Example 5

In Example 5, a crosslinked acrylic acid polymer membrane containing a carboxylic acid as the proton-donating group, hereafter called as CL-A membrane, was synthesized using the same technique as in Example 1 except for using tert-butyl acrylate in place of n-butyl styrene sulfonate in the first step and using trifluoroacetic acid and dichloromethane in the second step. The amount of H₂SO₄ and methanol used was changed accordingly, and the CL-A membrane was swollen with H₂SO₄ to prepare a proton-conducting membrane (thickness: 0.086 cm). The mass ratio of CL-A to H₂SO₄ is 20:80, and the molar ratio of H₂SO₄ (plasticizer) to repeating units containing carboxylic acid groups (i.e. proton-donating groups) is 3.0, as determined by the following Formula (6).

Molar ratio of H₂SO₄ to repeating units containing carboxylic acid groups=Moles of H₂SO₄/Moles of acrylic acid monomer units in crosslinked polymer (6)

AC impedance measurements were carried out in the same manner as in Example 1 to measure the proton conductivity under non-humidified conditions. The measurement results are shown in Table 1 and FIG. 5, and are represented by black triangle (▴) plot points and a dashed line connecting them in FIG. 5. Under non-humidified conditions and in the temperature range of from 20 to 125° C., the proton-coducting membrane of Example 5 exhibited a proton conductivity of from 0.011 to 0.075 S/cm (11 to 75 mS/cm), which was comparable to that of Comparative Example 1 despite the low acidity of the proton-donating group in the polymer.

The details of the proton-conducting membranes of the above-described Examples and Comparative Examples are shown in Table 2 below.

TABLE 2
(Table 1 Proton conductivity results)

| | Proton Conductivity (S/cm) | | | | | | | | | |
|---|---|---|---|---|---|---|---|---|---|---|
| | Measurement | | | | | | | | | |
| | conditions | 20° C. | 35° C. | 50° C. | 65° C. | 80° C. | 95° C. | 110° C. | 120° C. | 125° C. |
| Example 1 | Non- | 0.052 | 0.079 | 0.11 | 0.15 | 0.18 | 0.22 | 0.25 | n.d. | 0.28 |
| | humidified | | | | | | | | | |
| Comparative | Non- | n.d. | n.d. | 0.087 | n.d. | 0.12 | 0.14 | 0.15 | 0.16 | n.d. |
| Example 1 | humidified | | | | | | | | | |
| Comparative | Humidified | 0.0054 | 0.0084 | 0.013 | 0.018 | 0.027 | 0.054 | n.d. | n.d. | n.d. |
| Example 2 | (90% RH) | | | | | | | | | |
| Comparative | Non- | 0.000000061 | 0.00000033 | 0.0000014 | 0.0000045 | 0.000013 | 0.0000031 | 0.000071 | n.d. | 0.00015 |
| Example 3 | humidified | | | | | | | | | |
| Comparative | Non- | n.d. | 0.000009 | 0.000016 | 0.000034 | 0.000074 | 0.00016 | 0.0031 | n.d. | 0.00057 |
| Example 4 | humidified | | | | | | | | | |
| Example 2 | Non- | 0.0094 | 0.016 | 0.025 | 0.038 | 0.054 | 0.076 | 0.086 | n.d. | 0.1 |
| | humidified | | | | | | | | | |

TABLE 2
(Table 2 Details of proton-conducting membrane of Examples and Comparative Examples)

| | | | | | Molar | |
|---|---|---|---|---|---|---|
| | | | | | ratio of | |
| | | | | | plasticizer | |
| | | | | | to | |
| | | | | | repeating | |
| | | | | | units | |
| | | | | | containing | Form of |
| | Crosslinked polymer | | Plasticizer | | proton- | proton- |
| | | Content | | Content | donating | conducting |
| | Type | (mass %) | Type | (mass %) | groups | membrane¹⁾ |
| Example 1 | CL-SS | 20 | Sulfuric | 80 | 7.6 | Viscoelastic |
| | | | acid | | | solid |
| Comparative | CL-P | 18 | Sulfuric | 82 | 5.0²⁾ | Viscoelastic |
| Example 1 | | | acid | | | solid |
| Comparative | Nafion | 100 | — | — | — | n.d. |
| Example 2 | | | | | | |
| Comparative | Nafion | 100 | — | — | — | Glassy |
| Example 3 | | | | | | solid |
| Comparative | Nafion | 85 | Sulfuric | 15 | 0.52 | Glassy |
| Example 4 | | | acid | | | solid |
| Example 2 | CL-SS | 50 | Sulfuric | 50 | 1.9 | Viscoelastic |
| | | | acid | | | solid |
| Comparative | CL-P | 45 | Sulfuric | 55 | 1.3³⁾ | Glassy |
| Example 5 | | | acid | | | solid |
| Comparative | uncrosslinked | 50 | Sulfuric | 50 | 1.9 | Flowable |
| Example 6 | PSS | | acid | | | |
| Example 3 | CL-SS | 80 | Sulfuric | 20 | 0.48 | Viscoelastic |
| | | | acid | | | solid |
| Example 4 | CL-SS | 20 | Phosphoric | 80 | 7.6 | Viscoelastic |
| | | | acid | | | solid |
| Example 5 | CL-A | 20 | Sulfuric | 80 | 3.0 | Viscoelastic |
| | | | acid | | | solid |

Note:
¹⁾“form of proton-conducting membrane” is a form confirmed at from 20° C. to 125° C.
²⁾The value of “5.0” is the molar ratio value of the plasticizer to repeating units containing proton-accepting groups (pyridyl groups).
³⁾The value of “1.3” is the molar ratio value of the plasticizer to repeating units containing proton-accepting groups (pyridyl groups).

1. A proton-conducting membrane, comprising:
a crosslinked polymer and a plasticizer,
wherein the crosslinked polymer includes repeating units containing proton-donating groups in an amount equal to 10 mol % or more of repeating units constituting the crosslinked polymer,
wherein at least 60 mass % of the plasticizer is a proton-donating compound with a pKa of 2.5 or less, and,
wherein the proton-conducting membrane is a viscoelastic solid in a temperature range of from 20° C. to 125° C.

2. The proton-conducting membrane according to claim 1, wherein at least 80 mass % of the plasticizer is the proton-donating compound.

3. The proton-conducting membrane according to claim 1, wherein the repeating unit containing a proton-donating group is in an amount equal to 50 mol % or more of the repeating units constituting the crosslinked polymer.

4. The proton-conducting membrane according to claim 1, wherein the molar ratio of the plasticizer to the repeating unit containing the proton-donating group (the plasticizer/the repeating unit containing the proton-donating group) is from 0.4 to 8.0.

5. The proton-conducting membrane according to claim 1, wherein when the total of the crosslinked polymer and the plasticizer is 100 parts by mass, the content of the plasticizer is from 20 parts by mass to 90 parts by mass.

6. The proton-conducting membrane according to claim 1, wherein the molar ratio of the plasticizer to the repeating units containing proton-donating group (the plasticizer/the repeating unit containing the proton-donating group) is from 1.0 to 8.0.

7. The proton-conducting membrane according to claim 1, wherein when the total of the crosslinked polymer and the plasticizer is 100 parts by mass, the content of the plasticizer is from 50 parts by mass to 90 parts by mass.

8. The proton-conducting membrane according to claim 1, wherein the proton-donating compound is one or more selected from the group consisting of sulfuric acid and phosphoric acid.

9. The proton-conducting membrane according to claim 1, wherein the proton-donating group is at least one selected from the group consisting of a sulfonic acid group, a phosphonic acid group, and a carboxylic acid group.

10. The proton-conducting membrane according to claim 1, wherein the crosslinked polymer is a copolymer of a first monomer, which is a vinyl monomer containing a proton-donating group, and a second monomer, which is a crosslinkable vinyl monomer.

11. The proton-conducting membrane according to claim 1, wherein the proton conductivity is 0.00048 S/cm or more at 50° C.

12. A fuel cell comprising the proton-conducting membrane according to claim 1.
